(19) United States
(12) Patent Application Publication
(10) Pub. No.: US 2009/0146830 A1
(43) Pub. Date: Jun. 11, 2009

(54) ELECTRONIC SECURITY SYSTEM AND REMOTE-OPERATING PORTABLE ELECTRONIC KEY USED FOR THE SAME

(75) Inventor: Hiroyuki OGISO, Ina-shi (JP)

Correspondence Address: OLIFF & BERRIDGE, PLC, P.O. BOX 320850, ALEXANDRIA, VA, 22320-4850, US

(73) Assignee: EPSON TOYOCOM CORPORATION, TOKYO (JP)

(21) Appl. No.: 12/061,354

(22) Filed: Apr. 2, 2008

(30) Foreign Application Priority Data
Apr. 11, 2007 (JP) 2007-104280

(51) Int. Cl. G05B 19/02

(52) U.S. Cl. 340/825.22

(57) ABSTRACT

A small-sized electronic security system superior in emergent response and capable of obtaining power from other electronic apparatuses even in the case in which a portable electronic key suffers from battery exhaustion, and a remote-operating portable electronic key therefor are obtained.

The electronic security system is applied to a remote-operating system for in-vehicle equipment. The electronic key is composed of an electronic key housing on which a power supply is mounted and an electronic key module arranged to be able to be detachably attached to the electronic key housing and provided with a transmission/reception antenna, signal verification means, and operation control means for the in-vehicle equipment. The electronic key module has a feeding terminal layout common to an interchangeable module of another electronic apparatus and an outer shape identical thereto so that the electronic key module can be interchanged to the another electronic apparatus for an emergency operation in the case in which the electronic key module becomes inoperative due to battery exhaustion in an normal operation condition of being inserted in the electronic key housing.

### TECHNICAL FIELD

The present invention relates to an electronic security system and a remote-operating portable electronic key used therefor, and in particular to an electronic security system and a remote-operating portable electronic key therefor arranged to be capable of operating unlocking and locking of a door of a vehicle or a house from a remote location.

### BACKGROUND ART

In the past, an electronic security system arranged to be capable of performing locking/unlocking operations without using a hand in locking/unlocking a door key of a vehicle or a door key of a house has been known. For example, there has been known one for performing electronic verification or unlocking by a transmission/reception operation without mechanically locking/unlocking a door or an engine of a car with a key brought by an operator in opening/closing the door or the engine of the car. As an example of such a system, there can be cited a smart key system (registered trademark), an intelligent key (registered trademark) system, and so on.

In these systems, although locking/unlocking can be performed by electronic verification in an electronic lock in response to an operation of the key brought by an operator, since the key is driven by a battery, battery exhaustion occurs inevitably. Therefore, various kinds of technical measures for coping with the battery exhaustion have been taken in the past.

For example, what has a power supply used inside the portable circuit is described in Patent Document 1. Further, what has a key function signal generation circuit in a watch in addition to a mechanical key built-in in the watch is described in Patent Document 2. Moreover, as described in Patent Document 3, what is arranged to obtain power from the outside with electricity receiving means has also been known.

[Patent Document 1] JP-A-2000-96891

[Patent Document 2] JP-A-2004-100346

[Patent Document 3] JP-A-2005-314962

### DISCLOSURE OF THE INVENTION

However, the past electronic security system described above has a disadvantage that the electronic key to be brought by an operator problematically needs to have two or more power supplies and mechanical keys added thereto, which incurs increase in cost or growth in size of the electronic key.

The invention has been made for solving at least a part of the problem described above, and can be realized as following aspects or application examples.

### APPLICATION EXAMPLE 1

An electronic security system for performing unlocking and locking of a door includes a remote-operating portable electronic key including an electronic key housing provided with a battery, and an electronic key module arranged to be detachably attached to the electronic key housing, and fed with power by the battery to be driven, and a door electronic locking device for performing wireless communication with the remote-operating portable electronic key to perform unlocking and locking of the door, and the electronic key module is attached to another electronic apparatus to supply power to the electronic key module from the another electronic apparatus when the battery in the electronic key housing runs out, thereby enabling the electronic key module and the door electronic locking device to perform wireless communication with each other.

According to the present configuration, there can be configured a system capable of making an emergent operation such as unlocking or locking be executed by receiving power supply from another electronic apparatus and so on brought by a user even when the battery exhaustion of the remote-operating portable electronic key occurs.

### APPLICATION EXAMPLE 2

In the electronic security system according to Application Example 1, the electronic key module includes an electronic key basic circuit for performing the wireless communication with the door electronic locking device, the electronic key housing Includes a module insertion socket to which the electronic key module is inserted, the module insertion socket being provided with a feeding terminal, the feeding terminal being connected to the battery, and the electronic key module has a power supply terminal at a position corresponding to the feeding terminal of the module insertion socket, the power supply terminal being connected to the electronic key basic circuit.

According to the present configuration, in the case in which the battery of the electronic key housing runs out, it becomes possible to make the electronic security system perform an emergent operation by detaching the electronic key module from the electronic key housing and inserting it into the socket (slot) of an external electronic apparatus so as to supply the electronic key module with power.

### APPLICATION EXAMPLE 3

In the electronic security system according to Application Example 2, the electronic key module has a layout of the power supply terminal and an outer shape identical to those of an interchangeable module detachably attached to the another electronic apparatus so as to be able to be supplied with power from the another electronic apparatus.

According to the present configuration, since the position of the feeding terminal and the outer shape are identical to those of the interchangeable module detachably attached with an insertion socket in another electronic apparatus such as a computer, portable terminal equipment, or a game machine, the power supply can be received from the electronic apparatus by inserting the electronic key module into the electronic apparatus, thus an emergent action can be taken.

### APPLICATION EXAMPLE 4

In the electronic security system according to Application Example 1, the electronic key module has an outer shape and a layout of the power supply terminal compliant to at least one of an SD card, compact flash (registered trademark), smart media (registered trademark), memory stick (registered trademark), multimedia card (registered trademark), USB, and a small PC card.

According to the present configuration, the electronic key module can be interchangeably attached to the socket to which the media identical to a low-profile memory card, or used for game cartridge, a computer, or a portable terminal, thus the electronic key module can be operated emergently while receiving the power supply therefrom.

### APPLICATION EXAMPLE 5

In a remote-operating portable electronic key used for the electronic security system according to Application Example 1, the electronic key module includes an electronic key basic circuit for performing the wireless communication with the door electronic locking device, the electronic key housing includes a module insertion socket to which the electronic key module is inserted, the module insertion socket being provided with a feeding terminal, the feeding terminal being connected to the battery, and the electronic key module has a power supply terminal at a position corresponding to the feeding terminal of the module insertion socket, the power supply terminal being connected to the electronic key basic circuit.

The remote-operating portable electronic key used in the electronic security system described above can perform emergent unlocking of the door by applying power from another electronic apparatus such as a cellular phone in the case of battery exhaustion.

### APPLICATION EXAMPLE 6

In the remote-operating portable electronic key according to Application Example 5, the electronic key module has a layout of the power supply terminal and an outer shape identical to those of an interchangeable module detachably attached to the another electronic apparatus so as to be able to be supplied with power from the another electronic apparatus.

According to the present configuration, since the position of the feeding terminal and the outer shape are identical to those of the interchangeable module detachably attached with an insertion socket in another electronic apparatus such as a computer, portable terminal equipment, or a game machine, there can be provided a remote-operating portable electronic key capable of receiving the power supply from the electronic apparatus by inserting the electronic key module into the electronic apparatus, thereby performing an emergent action.

### BRIEF DESCRIPTION OF THE DRAWINGS

FIG. 1 is a plan view of a remote-operating electronic key according to an embodiment of the invention.

FIG. 2 is a plan view of a condition in which a module of the remote-operating electronic key is detached.

FIG. 3 is a block diagram of a circuit configuration of the remote-operating electronic key.

FIG. 4 is an explanatory diagram of an electronic security system applied to a vehicle equipment remote-operating system according to an embodiment of the invention.

### BEST MODE FOR CARRYING OUT THE INVENTION

Hereinafter, a specific embodiment of an electronic security system according to the invention and a remote-operating portable electronic key used therefor will be explained in detail with reference to the drawings.

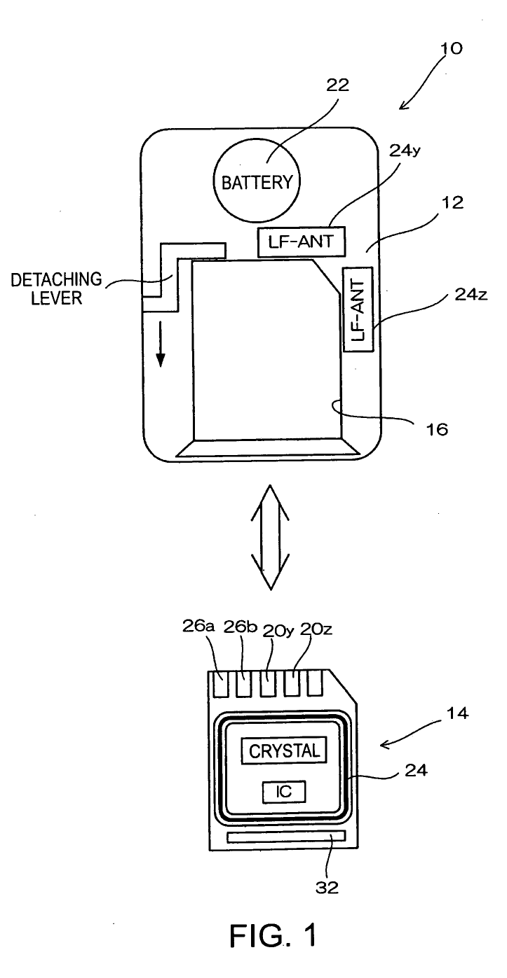

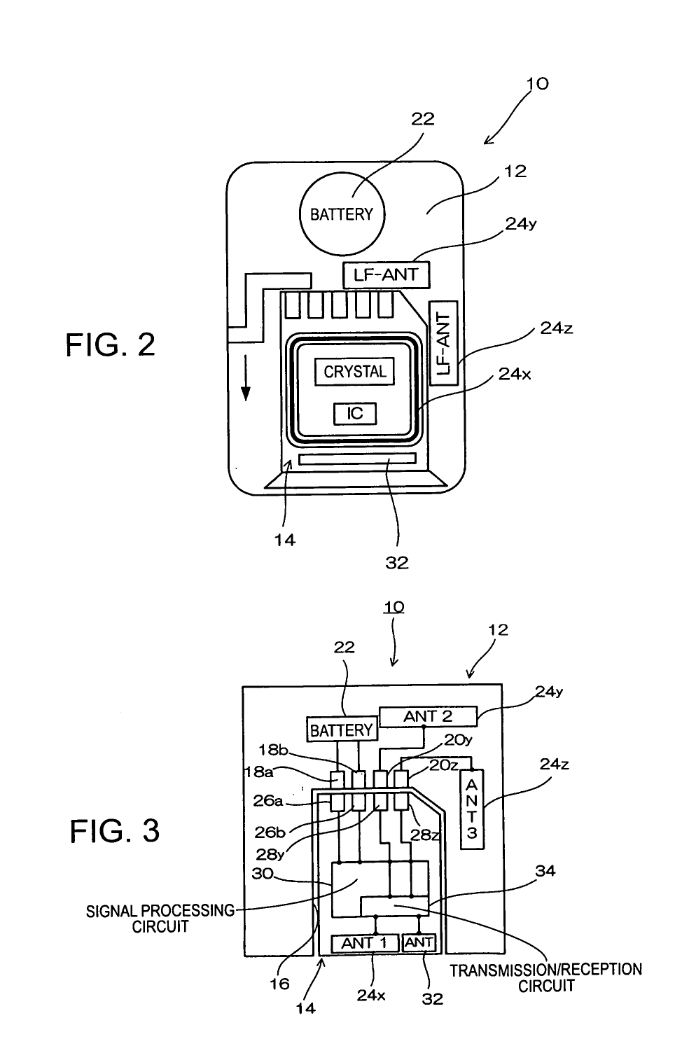

FIG. 1 shows a plan view of a remote-operating portable electronic key 10 in the condition of being separated into an electronic key housing 12 and an electronic key module 14, and FIG. 2 shows the condition of attaching the electronic key module 14 to the electronic key housing 12. Further, FIG. 3 shows a schematic configuration of these circuits.

As shown in FIG. 2, the remote-operating portable electronic key 10 is arranged to be brought by an operator in the condition of attaching the electronic key module 14 to the electronic key housing 12, and to allow the operator to detach the electronic key module 14 and insert the electronic key module 14 into an interchangeable module socket of another electronic apparatus so that the electronic key module 14 can emergently be used while obtaining power from the another electronic apparatus when the battery runs out.

In the present embodiment, the electronic key module 14 is formed to have a shape of an SD memory card. Firstly, the electronic key housing 12 to which the electronic key module 14 is attached is provided with a module insertion socket 16 so that the electronic key module 14 is inserted thereto to achieve electrical connection between the both elements. Thus, there is formed the remote-operating portable electronic key 10 for a small-sized electronic security system superior in emergent response and capable of obtaining power from other electronic apparatuses even in the case in which the portable electronic key suffers from battery exhaustion.

Further, as shown in FIG. 3, on the electronic housing 12 side, there are provided on the inside back of the module insertion socket 16, feeding terminals 18a, 18b for supplying at least the electronic key module 14 with power and antenna terminals 20y, 20z to be connected to two reception antennas as connection terminals. In addition, a power supply battery 22 for feeding the feeding terminals 18a, 18b is implemented in the electronic key housing 12. Further, since the reception antenna uses a directional wave, the antenna oriented on three orthogonal axis directions is required therefor, and it is arranged that reception is performed by the antenna terminals 20y, 20z by implementing reception antennas 24y, 24z along at least two axes (the Y-axis and the Z-axis) out of the three orthogonal axes in the electronic key housing 12. It should be noted that the module insertion socket 16 of the electronic key housing 12 is arranged to have the same shape as a socket (slot) defined by the SD memory card standard so that the electronic key module 14 can be inserted and removed.

Meanwhile, the outer shape of the electronic key module 14, which is arranged to be able to be detachably attached to the electronic key housing 12, is arranged to be the same as an outer shape defined by the SD memory card standard, and power supply terminals 26a, 26b to be connected to the feeding terminals 18a, 18b and reception terminals 28y, 28z to be connected to the antenna terminals 20y, 20z are provided. The power supply terminals 26a, 26b are formed at the same positions as the positions of the power supply terminals defined by the SD memory standard. A signal processing circuit 30 connected to these terminals 26a, 26b, 28y, and 28z is implemented in the electronic key module 14. Further, the remaining reception antenna 24x and a transmission antenna 32 are attached thereto, and these antennas and the terminals 28y, 28z are connected to a transmission/reception circuit 34. In other words, the electronic key module has a configuration provided with an electronic key basic circuit composing operation control means for in-vehicle equipment, and is arranged to keep the function as the electronic key even when detached from the electronic key housing 12 although the connection with the power supply battery is cut.

The remote-operating portable electronic key 10 according to such a configuration normally forms a single unit with the electronic key module 14 attached to the electronic key housing 12 as shown in FIG. 2, and is arranged to accept power from the power supply battery 22 in this condition and to use a so-called smart entry system with a vehicle drive control system. When the power supply battery 22 runs out, as shown in FIG. 1, the electronic key module 14 is detached from the electronic key housing 12, and is inserted into a memory slot of another electronic apparatus to be used as an emergent action.

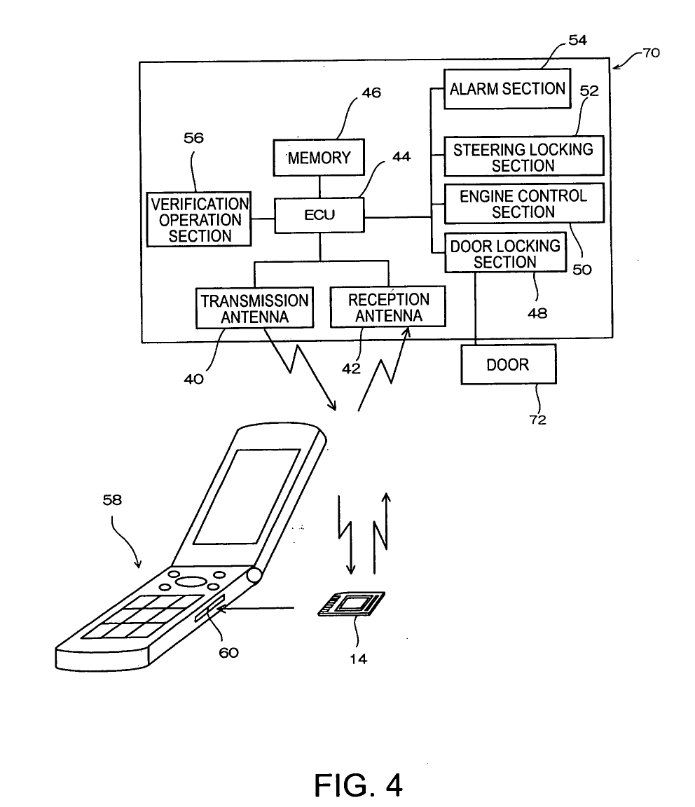

FIG. 4 shows this condition, which shows an application to a remote-operating system for in-vehicle equipment. As shown in an upper block diagram of FIG. 4, a door electronic lock device 70 provided to the vehicle is provided with a transmission antenna 40 and a reception antenna 42 both connected to an engine control unit (ECU) 44 as vehicle drive control means. To the ECU 44, there are connected a memory 46, and drive equipment as a target of control such as a door locking section 48, an engine control section 50, a steering locking section 52, or an alarm section 54 in addition thereto. Further, the ECU 44 has a verification operation section 56 connected thereto. The remote-operating system performs wireless communication with the remote-operating portable electronic key 10 by transmitting/receiving radio waves using the transmission antenna 40 and the reception antenna 42, performs verification of an ID number with the memory 46 in the verification operation section 56, and performs unlocking or locking of the door 72 by the door locking section 48 if the ID number is correct.

In the present embodiment, it is possible to detach the electronic key module 14 from the electronic key housing 12 with the exhausted battery, and insert the electronic key module 14 into a slot 60 of a cellular phone 58 as another electronic apparatus to receive power supply from the cellular phone 58. When receiving the power supply, the electronic key module 14 transmits a signal for performing unlocking to the door electronic locking device 70 with the wireless communication, thus the door 72 is unlocked. According to this operation, the remote operation of the vehicle equipment can be activated as an emergent action by the cellular phone 58 in the case of battery exhaustion.

Further, although in the present embodiment it is arranged that the outer shape of the electronic key module 14 is the same as the outer shape defined by the SD memory card standard, and the shape of the module insertion socket 16 is the same as the shape of the socket (slot) defined by the SD memory card standard, it is also possible to apply other memory card standard than the SD memory card standard such as compact flash (registered trademark), smart media (registered trademark), memory stick (registered trademark), multimedia card (registered trademark), USB, or a small PC card.

As described above, it is arranged that the remote-operating portable electronic key 10 is separated into the electronic key housing 12 having the power supply battery 22 mounted thereon and the electronic key module 14 provided with the electronic key basic circuit so as to be detachably attached, and the electronic key module 14 has the outer shape and power supply terminals commonly standardized so as to be used in other electronic apparatuses, thereby eliminating necessity of providing the remote-operating portable electronic key 10 with any additional equipment such as a secondary power supply or a mechanical key. Therefore, the counter measure for battery exhaustion can be realized with extreme ease.

1. An electronic security system for performing unlocking and locking of a door, comprising:
a remote-operating portable electronic key including
an electronic key housing provided with a battery, and
an electronic key module arranged to be detachably attached to the electronic key housing, and fed with power by the battery to be driven; and
a door electronic locking device for performing wireless communication with the remote-operating portable electronic key to perform unlocking and locking of the door,
wherein the electronic key module is attached to another electronic apparatus to supply power to the electronic key module from the another electronic apparatus when the battery in the electronic key housing runs out, thereby enabling the electronic key module and the door electronic locking device to perform wireless communication with each other.

2. The electronic security system according to claim 1,
wherein the electronic key module includes an electronic key basic circuit for performing the wireless communication with the door electronic locking device,
the electronic key housing includes a module insertion socket to which the electronic key module is inserted, the module insertion socket being provided with a feeding terminal, the feeding terminal being connected to the battery, and
the electronic key module has a power supply terminal at a position corresponding to the feeding terminal of the module insertion socket, the power supply terminal being connected to the electronic key basic circuit.

3. The electronic security system according to claim 2,
wherein the electronic key module has a layout of the power supply terminal and an outer shape identical to those of an interchangeable module detachably attached to the another electronic apparatus so as to be able to be supplied with power from the another electronic apparatus.

4. The electronic security system according to claim 1,
wherein the electronic key module has an outer shape and a layout of a power supply terminal compliant with at least one of an SD card, compact flash (registered trademark), smart media (registered trademark), memory stick (registered trademark), multimedia card (registered trademark), USB, and a small PC card.

5. A remote-operating portable electronic key used for the electronic security system according to claim 1,
wherein the electronic key module includes an electronic key basic circuit for performing the wireless communication with the door electronic locking device,
the electronic key housing includes a module insertion socket to which the electronic key module is inserted, the module insertion socket being provided with a feeding terminal, the feeding terminal being connected to the battery, and
the electronic key module has a power supply terminal at a position corresponding to the feeding terminal of the module insertion socket, the power supply terminal being connected to the electronic key basic circuit.

6. The remote-operating portable electronic key according to claim 5,
wherein the electronic key module has a layout of the power supply terminal and an outer shape identical to those of an interchangeable module detachably attached to the another electronic apparatus so as to be able to be supplied with power from the another electronic apparatus.
